(19) United States
(12) Patent Application Publication
(10) Pub. No.: US 2026/0140595 A1
(43) Pub. Date: May 21, 2026

(54) CAPTURING EMBEDDED FUNCTIONALITY WITH MOBILE SCREENSHOT

(71) Applicant: INTERNATIONAL BUSINESS MACHINES CORPORATION, Armonk, NY (US)

(72) Inventors: Logan Bailey, Atlanta, GA (US); Zachary Augustus Silverstein, Georgetown, TX (US); Jeremy R. Fox, Georgetown, TX (US)

(21) Appl. No.: 18/950,880

(22) Filed: Nov. 18, 2024

(51) Int. Cl. G06F 3/0481; G06F 3/04842; G06F 9/451; G06V 10/40

(52) U.S. Cl. CPC G06F 3/0481; G06F 3/04842; G06F 9/451; G06V 10/40

(57) ABSTRACT

Generation and use of screenshots of interactive displays are provided. A screenshot is received. The screenshot comprises an area of an interactive display. An interactive object is identified within the area of the interactive display. The interactive object corresponds to a function. A simulated interactive object corresponding to the interactive object is generated. The simulated interactive object corresponds to the function. A composite screenshot comprising the screenshot and the simulated interactive object is rendered for display, on a display.

### BACKGROUND

Embodiments of the present disclosure relate to interactive digital content, and more specifically, to generating and using screenshots of interactive displays. The landscape of user digital interactions, e.g., on social media, is evolving to include interactive elements embedded in digital content. Examples of such interactive elements include buttons, links, and hyperlinks. Trackable hyperlinks can be used for marketing, shortcut hyperlinks to user profiles can be used for tagging people, products, etc., in images, and interactive buttons can be used for user input or increased visibility. Alternative methods of mobile screenshotting allow for the replication of image data, but do not allow for the replication of the functionalities of interactive elements embedded in the original digital content. Accordingly, there is a need for a mobile screenshotting technology that captures embedded interactive elements and their functionalities.

### BRIEF SUMMARY

According to embodiments of the present disclosure, systems for, computer program products for, and computer-implemented methods of generating and using screenshots of interactive displays are provided. In some embodiments, a computer-implemented method of generating and using a composite screenshot of an interactive display is provided. The computer-implemented method comprises the following steps: A screenshot is received. The screenshot comprises an area of an interactive display. An interactive object is identified within the area of the interactive display. The interactive object corresponds to a function. A simulated interactive object corresponding to the interactive object is generated. The simulated interactive object corresponds to the function. A composite screenshot comprising the screenshot and the simulated interactive object is rendered for display, on a display.

In some embodiments, a system is provided. The system comprises a computing node. The computing node comprises a computer readable storage medium having program instructions embodied therewith. The program instructions are executable by a processor of the computing node to cause the processor to perform a method. The method comprises the following steps. The processor receives a screenshot. The screenshot comprises an area of an interactive display. The processor identifies an interactive object within the area of the interactive display. The interactive object corresponds to a function. The processor generates a simulated interactive object corresponding to the interactive object. The simulated interactive object corresponds to the function. The processor renders for display, on a display, a composite screenshot comprising the screenshot and the simulated interactive object.

In some embodiments, a computer program product for generating and using a composite screenshot of an interactive display is provided. The computer program product comprises a computer readable storage medium having program instructions embodied therewith. The program instructions are executable by a processor to cause the processor to perform a method. The method comprises the following steps. The processor receives a screenshot. The screenshot comprises an area of an interactive display. The processor identifies an interactive object within the area of the interactive display. The interactive object corresponds to a function. The processor generates a simulated interactive object corresponding to the interactive object. The simulated interactive object corresponds to the function. The processor renders for display, on a display, a composite screenshot comprising the screenshot and the simulated interactive object.

### BRIEF DESCRIPTION OF THE SEVERAL VIEWS OF THE DRAWINGS

FIG. 1 depicts a flowchart illustrating a method according to embodiments of the present disclosure.

FIG. 2 depicts a flowchart illustrating an exemplary method according to embodiments of the present disclosure.

FIG. 3 is a schematic illustrating an example of a computing node according to embodiments of the present disclosure.

### DETAILED DESCRIPTION

The present disclosure provides for mobile screenshot images that can be enriched via the replication/capturing of interactive elements embedded in the image being screenshotted, along with the functionalities of the embedded interactive elements.

In some embodiments, a module can analyze digital screenshot images to identify one or more embedded interactive elements and their functionalities. In some embodiments, such analysis can be based on one or more computer vision techniques used to identify one or more regions of the screenshot. In some embodiments, object detection can be used. In some embodiments, image segmentation can be used. In some embodiments, image classification can be used. In some embodiments, semantic segmentation can be used. In some embodiments, instance segmentation can be used. In some embodiments, edge detection can be used. In some embodiments, pose estimation can be used. In some embodiments, deep learning can be used for object detection, segmentation, edge detection, pose estimation, and/or the like. For example, the one or more embedded interactive elements can comprise a play button on a video thumbnail image. As another example, the one or more embedded interactive elements can comprise a “Buy Now” button on a product image. As yet another example, the one or more embedded interactive elements can comprise a “Read More” hyperlink on an image of an article preview.

In some embodiments, a module can allow users to directly interact with an element embedded in an image by directly interacting with a screenshot of the image. For example, the user's interaction with the element can comprise the user's tapping of a play button redirecting the user to an associated hosted video. As another example, the user's interaction with the element can comprise the user's tapping of a “Shop Now” button instantiating the user's preferred browser to navigate to an associated product page. As yet another example, the user interaction with the element can comprise the user's tapping of a user profile tag redirecting the user to a user profile webpage. As another example, the user interaction with the element can comprise the user's tapping of a user profile tag redirecting the user to a webpage containing a social media post.

In some embodiments of the present disclosure, a module can detect user interaction with a certain region or object of a screenshot of an image. In response, the module can trigger an action simulating an action associated with the interactive element embedded in the same object or region of the image.

In some embodiments, a module can adapt the design of a replicated interactive element in a screenshot of an image according to post-processing of the screenshot by a user. The module's adaptation of the responsive element design can be based on dynamic region identification and inclusion. In some embodiments, such adaptation can be based on cropping of the screenshot. In some embodiments, such adaptation can be based on a reversion from cropping of the screenshot. For example, in response to the user cropping the screenshot to remove a region of the image that contains a replicated interactive element, the module can remove the replicated interactive element and its associated functionality from the screenshot.

In some embodiments, a module can implement security measures. The security measures can be implemented to avoid malicious actions and to ensure that user data is handled securely. For example, the module can automatically block the triggering of an action associated with an interactive element in a screenshot where the action involves the handling of sensitive data and/or involves navigation to a malicious website.

In some embodiments, a module can embed one or more event listeners into a screenshot to monitor user interactions with one or more interactive elements in the screenshot.

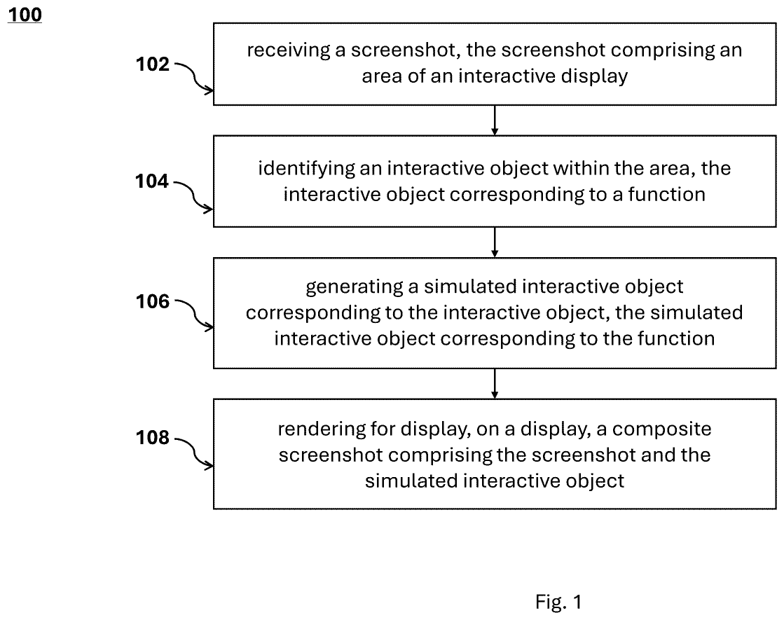

FIG. 1 depicts a flowchart 100 illustrating a method according to embodiments of the present disclosure. In some embodiments, at 102, a screenshot can be received. The screenshot can comprise an area of an interactive display. In some embodiments, at 104, an interactive object can be identified within the area of the interactive display. The interactive object can correspond to a function. In some embodiments, at 106, a simulated interactive object corresponding to the interactive object can be generated. The simulated interactive object can correspond to the function. In some embodiments, at 108, a composite screenshot comprising the screenshot and the simulated interactive object can be rendered for display, on a display.

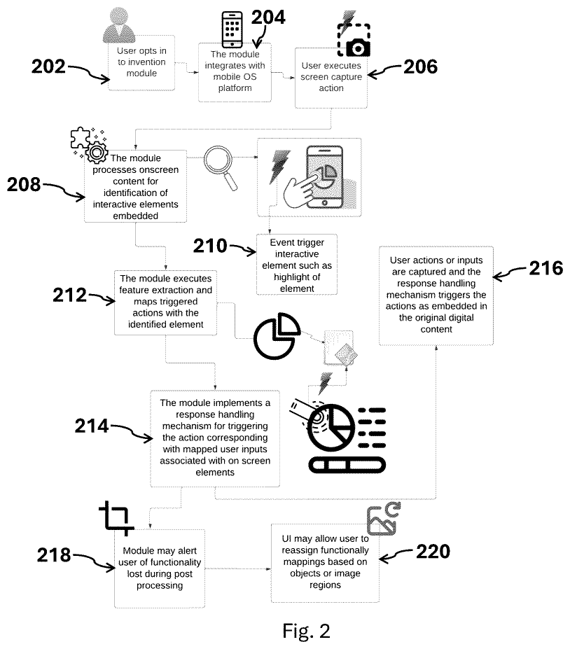

FIG. 2 depicts a flowchart 200 illustrating an exemplary method according to embodiments of the present disclosure. In some embodiments, at 202, a user can opt in to a module on a mobile device. For example, the module can be a photos settings and/or processing module on a mobile device. The module can include a set of processor-executable instructions that operate on a processor of the mobile device. The user can opt into the module by choosing a corresponding option in the photos settings of the mobile device.

In some embodiments, at 204, the module can integrate with the user's mobile platform, e.g., Android™, iOS™, etc. For example, the module can operate in conjunction with applications in operation by the user's mobile platform and it can automatically be engaged when screenshots are taken by the user's mobile phone. As another example, the module can be integrated as part of the device settings, such as the photos settings, of the user's mobile platform.

In some embodiments, at 206, the user can take a screenshot on the mobile device. For example, a user can press one or more buttons on the user's mobile device to capture a photo/screenshot of the content being displayed on the screen of the device at the moment that the button(s) are pressed.

In some embodiments, at 208, the module can process the onscreen content for identification of one or more embedded interactive elements, e.g., buttons, links, etc. For example, a user can take a screenshot of a social media posted photo that has embedded user profile tags—in this case, the module can process the social media posted photo to identify the user profile tags. In some embodiments, for such identification, the module can use one or more computer vision techniques. In some embodiments, the module can use object detection. In some embodiments, the module can use image segmentation. In some embodiments, the module can use image classification. In some embodiments, the module can use semantic segmentation. In some embodiments, the module can use instance segmentation. In some embodiments, the module can use edge detection. In some embodiments, the module can use pose estimation. In some embodiments, the module can use deep learning for object detection, segmentation, edge detection, pose estimation, and/or the like.

In some embodiments, at 210, each identified interactive element can have an associated action/event, such as navigation to a webpage, that can be triggered upon the module receiving user input, such as the user tapping on or highlighting the element. For example, for a screenshot of a social media posted photo with user profile tags, each identified user profile tag can trigger navigation to the corresponding user profile webpage upon the user tapping on the user profile tag.

In some embodiments, at 212, the module can perform feature extraction to map each identified interactive element to its associated action/event, such as navigation to a webpage, that can be triggered upon user input, such as the user tapping on or highlighting the interactive element. For example, for a screenshot of a social media posted photo with user profile tags, the module can perform feature extraction on each identified user profile tag to map the user profile tag to its associated webpage redirect that is triggered when the user taps on the user profile tag. In some embodiments, the feature extraction can be performed by the module automatically analyzing the functionality, such as the associated action/event, of each identified interactive element. In some embodiments, the feature extraction can be performed by reviewing metadata associated with each identified interactive element to determine its functionality. The metadata can be received and/or determined from the mobile platform and/or an application providing the interactive display that is screenshotted. In some embodiments, the feature extraction can be performed using natural language processing.

In some embodiments, at 214, the module can implement a response handling mechanism for triggering the action mapped to each onscreen interactive element upon user input associated with the interactive element, such as tapping or highlighting. For example, the module can implement a mechanism for navigating to the user profile webpage associated with a user profile tag in response to the user tapping on the user profile tag.

In some embodiments, at 216, upon capture of user input associated with an interactive element, the response handling mechanism can trigger the mapped action, e.g., as embedded in the original onscreen digital content. For example, a user can take a screenshot of a webpage that has an image with an embedded link. The user may provide a user input by clicking on one or more portions of the screenshot, and the user input may be received by the module described herein. Clicking on the image within the screenshot can then result in navigation to the embedded link. As another example, a user can take a screenshot of a social media post that has embedded user profile tags. Clicking on a user profile tag in the screenshot can then result in navigation to a webpage associated with the tagged user profile, or navigation to the original webpage of the social media post that was screenshotted.

In some embodiments, at 218, during user post-processing of the screenshot, e.g., cropping, the module can dynamically add or remove one or more interactive elements and their functionalities. In some embodiments, at 218, the module can notify the user of the removal or addition of each interactive element and its functionality. For example, a user can crop a screenshot to remove a region of the screenshot that contained an interactive element. The module can dynamically notify the user of the removal of the interactive element and its functionality from the screenshot.

In some embodiments, at 220, upon such notification, the user can remap the removed interactive element and its functionality to a region of the screenshot that remains after cropping. As an example, a user can take a screenshot of an social media shared image that includes user profile tags. The user can crop the screenshot to remove a region of the screenshot that contained a user profile tag. The user profile tag and its functionality can be removed from the screenshot, and the module can notify the user of this removal. The user can choose to remap the removed user profile tag to a different area of the screenshot that remains after cropping. Accordingly, the module can reassign the removed user profile tag and its functionality to the chosen area of the cropped screenshot.

In some embodiments, an interactive object, described herein, can correspond to embedded interactive element(s), referred to for example at 208 of FIG. 2. In some embodiments, the a function and/or functionality, described herein, can correspond to action(s)/event(s) that can be triggered based on user interactions with an identified interactive object/embedded interactive element, referred to for example at 212 of FIG. 2. In some embodiments, a simulated interactive object, described herein, can correspond to an object, as displayed in a composite screenshot, together with the original screenshot, such as what is described with reference to 206 of FIG. 2 and with reference to 216 of FIG. 2. For example, the user tapping on the simulated interactive object in the composite screenshot can constitute user input that causes the module to trigger navigation to an associated webpage. In some embodiments, a composite screenshot, as described herein, can correspond to the original screenshot once it has undergone processing, such as what is described with reference to 208, 212, and 214 of FIG. 2. In some embodiments, the composite screenshot can be the final version of the screenshot that is displayed to the user, referred to for example at 216 of FIG. 2.

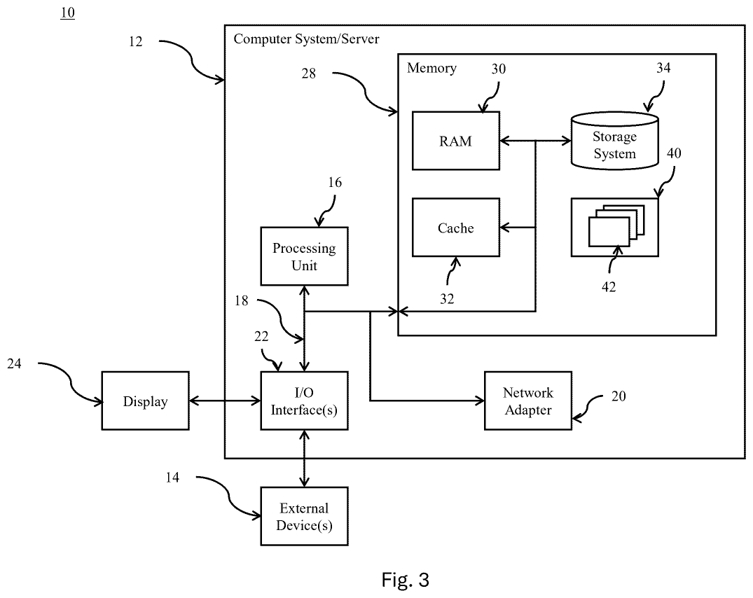

FIG. 3 is a schematic illustrating an example of a computing node according to embodiments of the present disclosure. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure. For example, memory 28 may include the module with functionalities to generate and use a composite screenshot, as described herein.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc. ; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method of generating and using a composite screenshot of an interactive display, the method comprising:
receiving a screenshot, the screenshot comprising an area of an interactive display;
identifying an interactive object within the area, the interactive object corresponding to a function;
generating a simulated interactive object corresponding to the interactive object, the simulated interactive object corresponding to the function; and
rendering for display, on a display, a composite screenshot comprising the screenshot and the simulated interactive object.

2. The method of claim 1, wherein identifying the interactive object within the area comprises:
performing at least one computer vision technique within the area to identify the interactive object, wherein the at least one computer vision technique comprises object detection or image segmentation; and
performing feature extraction on the interactive object to determine the function.

3. The method of claim 1, wherein generating the simulated interactive object corresponding to the interactive object comprises:
mapping the simulated interactive object to the function.

4. The method of claim 1, wherein the composite screenshot comprises a representation of the function.

5. The method of claim 1, further comprising receiving user input from a user, the user input corresponding to the composite screenshot.

6. The method of claim 5, wherein the simulated interactive object comprises a link, the user input comprises actuation of the link, and the link redirects the user to the interactive display containing the interactive object.

7. The method of claim 5, wherein the interactive object is a hyperlink to a location, the user input comprises actuation of the hyperlink, and the hyperlink redirects the user to the location.

8. The method of claim 7, wherein the location is a location at which a video can be watched.

9. The method of claim 5, wherein the user input comprises a post processing action to remove a portion of the composite screenshot, the portion containing the simulated interactive object; and wherein the method further comprises:
removing the simulated interactive object from the composite screenshot; and
providing a notification to the user of the removal of the simulated interactive object or the function.

10. A system comprising:
a computing node comprising a computer readable storage medium having program instructions embodied therewith, the program instructions executable by a processor of the computing node to cause the processor to perform a method comprising:
receiving a screenshot, the screenshot comprising an area of an interactive display;
identifying an interactive object within the area, the interactive object corresponding to a function;
generating a simulated interactive object corresponding to the interactive object, the simulated interactive object corresponding to the function; and
rendering for display, on a display, a composite screenshot comprising the screenshot and the simulated interactive object.

11. The system of claim 10, wherein identifying the interactive object within the area comprises:
performing at least one computer vision technique within the area to identify the interactive object, wherein the at least one computer vision technique comprises object detection or image segmentation; and
performing feature extraction on the interactive object to determine the function.

12. The system of claim 10, wherein generating the simulated interactive object corresponding to the interactive object comprises:
mapping the simulated interactive object to the function.

13. The system of claim 10, wherein the composite screenshot comprises a representation of the function.

14. The system of claim 10, further comprising receiving user input from a user, the user input corresponding to the composite screenshot.

15. The system of claim 14, wherein the simulated interactive object comprises a link, the user input comprises actuation of the link, and the link redirects the user to the interactive display containing the interactive object.

16. A computer program product for generating and using a composite screenshot of an interactive display, the computer program product comprising a computer readable storage medium having program instructions embodied therewith, the program instructions executable by a processor to cause the processor to perform a method comprising:
receiving a screenshot, the screenshot comprising an area of an interactive display;
identifying an interactive object within the area, the interactive object corresponding to a function;
generating a simulated interactive object corresponding to the interactive object, the simulated interactive object corresponding to the function; and
rendering for display, on a display, a composite screenshot comprising the screenshot and the simulated interactive object.

17. The computer program product of claim 16, wherein identifying the interactive object within the area comprises:
performing at least one computer vision technique within the area to identify the interactive object, wherein the at least one computer vision technique comprises object detection or image segmentation; and
performing feature extraction on the interactive object to determine the function.

18. The computer program product of claim 16, wherein generating the simulated interactive object corresponding to the interactive object comprises:
mapping the simulated interactive object to the function.

19. The computer program product of claim 16, wherein the composite screenshot comprises a representation of the function.

20. The computer program product of claim 16, further comprising receiving user input from a user, the user input corresponding to the composite screenshot.
